(19) United States
(12) Patent Application Publication
(10) Pub. No.: US 2023/0420204 A1
(43) Pub. Date: Dec. 28, 2023

(54) THERMAL FUSE

(71) Applicant: Dragonfly Energy Corp., Reno, NV (US)

(72) Inventors: Bayartsetseg Hopkins, Reno, NV (US); Ryan Hopkins, Reno, NV (US)

(73) Assignee: Dragonfly Energy Corp., Reno, NV (US)

(21) Appl. No.: 18/340,188

(22) Filed: Jun. 23, 2023

Related U.S. Application Data
(60) Provisional application No. 63/355,145, filed on Jun. 24, 2022.

(51) Int. Cl. H01H 37/48; H01H 37/72; H01H 37/64; H01H 71/18

(52) U.S. Cl. CPC H01H 37/48; H01H 37/72; H01H 37/64; H01H 71/18

(57) ABSTRACT

Thermal fuses and related methods of operation are disclosed. In some embodiments, a thermal fuse may include an insulating component and two electrodes operatively connected to the insulating component. Based on a difference in the thermal coefficients of expansion, the insulating component may expand axially relative to the electrodes with increasing temperature. As the insulating component expands the two electrodes may be moved axially apart to transition between an open and closed configuration. In some embodiments, the thermal fuse may transition between the open and closed configuration depending on whether or not an operating temperature of the thermal fuse is above or below a threshold temperature.

### CROSS-REFERENCE TO RELATED APPLICATIONS

This application claims the benefit of priority under 35 U.S.C. § 119(e) of U.S. Provisional Application Ser. No. 63/355,145, filed Jun. 24, 2022, the disclosure of which is incorporated herein by reference in its entirety.

### FIELD

Disclosed embodiments are related to thermal fuses.

### BACKGROUND

The use of thermal fuses is ubiquitous in many types of electrical systems. Thermal fuses are designed to break electrical contact when heat generated from operation of a circuit and/or temperatures from a surrounding environment result in a temperature of the thermal fuse above a threshold temperature. Typical thermal fuses are single use items. Accordingly, when activated, typical thermal fuses must be replaced.

### SUMMARY

In some embodiments, a thermal fuse includes a first electrode, a second electrode, and an insulating component operatively coupled to the first electrode and the second electrode. The insulating component is electrically insulating, and the insulating component is configured to place the first electrode in electrical contact with the second electrode when an operating temperature of the thermal fuse is less than a threshold temperature. The insulating component is also configured to space apart the first electrode from the second electrode when the operating temperature is greater than the threshold temperature.

In some embodiments, a method of operating a thermal fuse includes: expanding an insulating component to space apart a first electrode from a second electrode when an operating temperature of the thermal fuse is greater than a threshold temperature; and contracting the insulating component to place the first electrode in electrical contact with the second electrode when the operating temperature of the thermal fuse is less than the threshold temperature.

In some embodiments, a thermal fuse includes a first electrode and a second electrode separate from the first electrode, where the first electrode and the second electrode are selectively movable between an extended configuration in which the first electrode and the second electrode are spaced apart and a contracted configuration in which the first electrode and the second electrode are in electrical contact. The thermal fuse also includes an insulating component disposed at least partially between the first electrode and the second electrode. The insulating component is electrically insulating, and a coefficient of thermal expansion of the insulating component is greater than a coefficient of thermal expansion of at least one selected from the first electrode and the second electrode.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of one embodiment of a thermal fuse;

FIG. 2A is a schematic of a first electrode;

FIG. 2B is a schematic of an insulating component;

FIG. 3A is a front view of one embodiment of a thermal fuse;

FIG. 3B is a side view of one embodiment of a thermal fuse;

FIG. 4A is a schematic showing a contracted configuration of one embodiment of a thermal fuse;

FIG. 4B is a schematic showing the thermal fuse of FIG. 4A in an expanded configuration;

FIG. 5 is a schematic of another embodiment of a thermal fuse;

FIG. 6A is a schematic showing a state of yet another embodiment of a thermal fuse in a contracted configuration;

FIG. 6B is a schematic showing the thermal fuse of FIG. 6A in an expanded configuration;

FIG. 7 is a schematic of yet another embodiment of a thermal fuse;

FIG. 8A is a schematic of yet another embodiment of a thermal fuse;

FIG. 8B is a cross-sectional schematic of the embodiment of FIG. 8A taken at section 8B-8B;

FIG. 9A is a schematic of an electrode of the embodiment of FIG. 8A;

FIG. 9B is a schematic of an insulating component of the embodiment of FIG. 8A;

FIG. 9C is a cross-sectional schematic of an electrode and an insulating component of the embodiment of FIG. 8A assembled together;

FIG. 10A is a schematic of the embodiment of FIG. 8A in a contracted configuration; and

FIG. 10B is a schematic of the embodiment of FIG. 8A in an expanded configuration.

### DETAILED DESCRIPTION

During operation of certain electrical systems, over current events, elevated temperatures, and/or other undesirable events may occur. During such events, it may be desirable to interrupt normal operation of the system by opening one or more circuits of the system using a thermal fuse. However, conventional thermal fuses are non-resettable single use fuses. This leads to tedious replacing of components and a waste of materials.

In view of the above, the Inventors have recognized the benefits associated with a self-resetting thermal fuse. For example, the thermal fuses disclosed herein may open above a threshold temperature, stay open while the thermal fuse is maintained above the threshold temperature, and close once the thermal fuse cools to a temperature less than or equal to the threshold temperature.

In some embodiments, a thermal fuse may include at least two electrodes and an electrically insulating component. The electrically insulating component, and at least one of the electrodes may have a different thermal expansion coefficients. Due to this difference in thermal expansion coefficients and the overall construction of these components, the insulating component may be configured to place the first electrode in electrical contact with the second electrode when an operating temperature of the thermal fuse is less than a threshold temperature. For example, in some embodiments, the electrically insulating component may expand more than the corresponding electrode(s) when experiencing an increase in temperature which may cause movement of the electrodes relative to each other when the electrically insulating component expands and contracts during operation to either open or close the thermal fuse as elaborated on further below.

As used herein, thermal expansion may refer to a relative change in dimensions of a material with a corresponding change in temperature. Depending on the circumstance, this expansion can be uniform or nonuniform. The coefficient of thermal expansion of a material may be characterized by the equation:

$${α}_{L} = \frac{1}{L} \frac{d L}{d T}$$

where α_{L} is the coefficient of thermal expansion, dT is a change in temperature, dL is the change in length, and L is length. As noted above, in some embodiments, the change in length of the insulating component may be greater than a corresponding change in length of the one or more electrodes. In other words a coefficient of thermal expansion of the insulating component may be greater than a coefficient of thermal expansion of the one or more electrodes.

To move a thermal fuse between a closed state and an open state, the electrodes of the thermal fuse may be moved from being in electrical contact with one another to being spaced apart with a gap between the electrodes. For example, as the insulating component expands the two electrodes of a thermal fuse may be separated from one another. The sizing of the gap may be determined based on the desired application to avoid shorting across the gap. Appropriate parameters that may considered when selecting a gap size may include, but are not limited to, material conductivity, contact area, environmental composition (e.g., conductivity of the surrounding environment), potential between the two electrodes, and other appropriate parameters. It should be understood that larger currents and larger dimensions for thermal fuses may be associated with larger gaps between the electrodes of a thermal fuse when in the open configuration. As such the dimensions and spacings of the various components may correspond to any number of different configurations as the disclosure is not so limited.

In some embodiments, a gap present between two electrodes of a thermal fuse when the thermal fuse is in an open expanded configuration may be greater than or equal to 0.1 mm, 0.5 mm, 1 mm, 2 mm, 3 mm, 4 mm, 5 mm, or any other suitable range. In some embodiments, the gap between the two electrodes in the expanded configuration may be less than or equal to 10 mm, 5 mm, 4 mm, 3 mm, 2 mm, 1 mm, or any other suitable range. Combinations of foregoing are contemplated including, for example, a gap between the electrodes in the expanded configuration that is between or equal to 0.1 mm and 10 mm. Of course, should be understood that other gaps both greater than and less than those noted above are also contemplated as the disclosure is not so limited.

To provide a desired transition between a contracted and expanded configuration of a thermal fuse relative to temperature during operation, any appropriate ratio of a coefficient of thermal expansion of the insulating component and one or more electrodes of a thermal fuse may be selected. For example, the ratio of the coefficient of thermal expansion of the insulating component and at least one of the two electrodes may be any suitable range depending on the desired application. In some embodiments, the ratio of the coefficient of thermal expansion between the insulating component and the electrode may be greater than or equal to 1.1, 1.2, 1.3, 1.4, 1.5, 1.6, 1.7, 1.8, 1.9, 2.0, 2.1, 2.2, 2.3, 2.4, 2.5, and/or any other ratio above 1. In some embodiments, the ratio of coefficients of thermal expansion may be less than or equal to 2.5, 2.4, 2.3, 2.2, 2.1, 2.0, 1.9, 1.8, 1.7, 1.6, 1.5, 1.4, 1.3, 1.2, 1.1, and/or any other ratio above 1 indicating that the coefficient of thermal expansion of the insulating component is larger than that of the electrode. Of course, while specific ratios of the coefficients of thermal expansion are provided above, it should be understood that ratios both greater than and less than those noted above are also contemplated as the disclosure is not so limited.

In some embodiments, the electrodes may be made of any suitable conductive material. For example, electrodes may include, but are not limited to: metals such as copper, aluminum, gold, alloys of the forgoing, and other metals; electrically conductive polymers; electrically conductive composite materials and/or any other suitable conducting material.

An insulating component may be made from any appropriate material capable of electrically insulating one electrode from another electrode while providing the desired thermal expansion properties. This may include insulating components that are made from electrically insulating materials, insulating components including an electrically insulating coating disposed thereon, electrically insulating spacers disposed between the insulating component and an associated electrode, and/or any other number of configurations. Thus, it should be understood that at least a portion of an insulating component configured to contact one or more of the electrodes may be electrically insulated from the associated electrode and/or made from an electrically insulating material. For example, appropriate materials may include, but are not limited to: electrically insulating ceramics including alumina, diamond, and silica-based glasses; metals with an electrically insulating coating disposed thereon (e.g., anodized aluminum); electrically insulating polymers; combinations thereof; and/or any other appropriate material exhibiting the desired electrically insulating properties and differences in coefficient of thermal expansion relative to the electrodes of a thermal fuse.

In some embodiments, the components of a thermal fuse may be mechanically joined by a fastener. The system may include one or more fasteners to configured to bias the connected components of the thermal fuse towards one another. A variety of fasteners may be used for attaching components to one another including, but not limited to, threaded fasteners, clamps, mechanically interlocking features, and/or other appropriate mechanical fasteners. Additionally, in some embodiments, other methods for attaching the various components to one another may be used including, for example, adhesives and other types of attachment methods.

It should be understood that a thermal fuse and its components may include any combination of appropriate shapes and/or sizes that are capable of selectively placing a pair of electrode into and out of electrical contact with one another for a desired application. Further, size and scale of the assembly may also vary to accommodate different applications and operational preferences. For example, in some embodiments, the assembly may be designed to have a smaller overall mass and thinner components for faster temperature changes and opening times. In contrast, in other embodiments, the assembly may be designed to have a larger mass with thicker geometries to delay the response to change in operating temperature. The desired dimensions of a resettable thermal fuse may be determined based on these desired functionalities as well as appropriate parameters including, but not limited to, a composition of the surrounding environment; the potential difference between electrodes; the contact area between the two electrodes; as well as any number other factors.

The disclosed resettable thermal fuses may be used in any number of different applications. For example, depending on size a thermal fuse as disclosed herein may be used as an electrical component for small appliances or in large scale industrial and/or grid level applications. In some such embodiments, a thermal fuse could be in applications such as power distribution lines, transformers, household appliances, printed circuit board components, battery thermal fuses, power supplies, and virtually any other application where a thermal fuse may be used.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

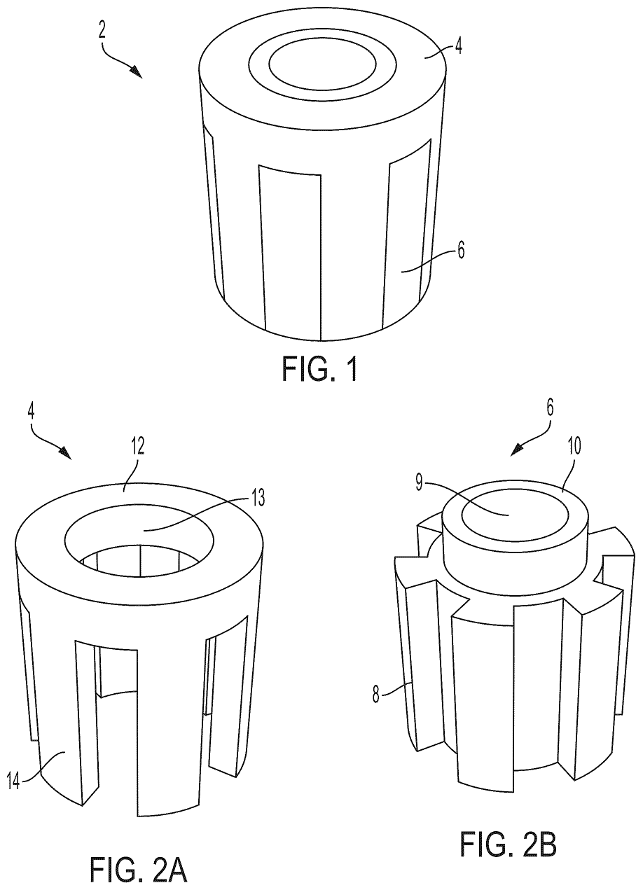

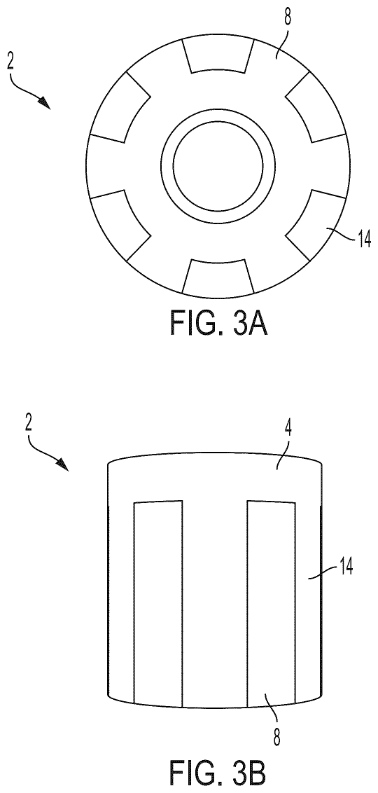

FIGS. 1-3B shows a schematic view of a first embodiment of a portion of a thermal fuse 2 with an approximately cylindrical shape. This geometry provides a large surface area of contact. However, the assembly may have any appropriate geometry such as, but not limited to, cylindrical arrangements with triangular, rectangular, polygonal, or other appropriately shaped cross section. Additionally, non-cylindrical geometries may also be used. The thermal fuse includes a first electrode 4 and an insulating component 6. The first electrode 4 may comprise a conducting body 12 and a hole 13 extending through the conducting body 12. Thus, in some embodiments, the conducting body may have an annular shaped body as depicted in the figure with two opposing surfaces. The first electrode 4 may also include a plurality of fingers 14 extending axially away from the conducting body, see FIG. 2A. In some instances, the fingers may be disposed around a perimeter of a transverse cross section of the conducting body. The insulating component 6 may include an insulating body 10 with a hole 9 extending axially through the insulating body. In some embodiments, one or more fins 8 may extend radially outward from the insulating body 10 and may extend along at least a portion of a length of the insulating body, see FIG. 2B. Additionally, the fins may be spaced axially from at least one adjacent end portion of the insulating body such that a portion of the insulating body extends axially outwards from the portion of the body including the fins. As shown in the figure, the portion of the insulating body extending outwards from the fins may be sized and shaped to be inserted into the through hole 13 of the electrode 4. Additionally, the fingers 14 of the first electrode and the fins 8 of the insulating component may be sized and shaped such that the fingers are received in the spaces disposed between adjacent fins when the electrode and the insulating component are assembled together. A fit between the fingers and the fins may be sufficiently loose to permit sliding contact between the insulating component and the electrode.

Assembly of a first embodiment of thermal fuse 2 may include inserting the portion of the insulating body 10 extending away from the fins 8 into the hole 13 of the conducting body 12 of the first electrode 4. An upper surface of the insulating component 10 adjacent to the protrusion may be in contact with an opposing surface of the conducting body 12 of the electrode. In this assembled configuration, the hole 9 of the insulating body and the hole 13 of the electrode may be concentrically located with one another in some embodiments. Further, the fingers 14 of the electrode 2 may be interdigitated with the fins 8 of the insulating component 6, so that each finger is disposed between two adjacent fins of the insulating component. Thus, the fins 8 may be viewed as being disposed in the alternating gaps between the electrode fingers 14. While the fingers and fins are illustrated as being disposed around an entire transverse cross-sectional perimeter of the electrode and insulating component, embodiments in which the fins and fingers, or other mated components are disposed along a portion of a perimeter or at another location on a thermal fuse are also contemplated. As elaborated on further below, in some embodiments, a length of the fingers and corresponding fins may be approximately equal to one another at room temperature (e.g. 20° C.).

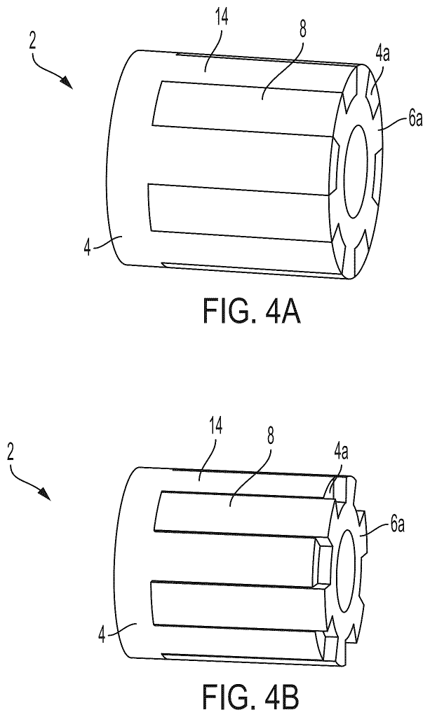

As shown in FIGS. 4A and 4B, a thermal fuse 2 may be configured to transition between an extended configuration and a contracted configuration depending on a temperature of the thermal fuse. FIG. 4A illustrates the thermal fuse 2 in a contracted configuration where a surface 4a of the electrode may be substantially flush with an adjacent surface 6a of the insulating component. In the depicted embodiment, surface 4a may correspond to distal surface of the individual fingers 14 of the electrode. As the temperature of the insulating component increases to a temperature above a threshold temperature, a length of the insulating component, including the depicted fins 8, may increase more than a length of the fingers 14, or other appropriate portion, of the electrode 4 until a difference in length of the associated components may be greater than a threshold gap length to electrically open the thermal fuse. This is illustrated by the increased length of the fins 8 protruding axially past the fingers 14 in FIG. 4B. Thus, the interdigitated portion of the fingers 14 may be spaced from the corresponding surface 6a of the insulating component such that there is a gap between the adjacent surfaces in the extended configuration. Thus, as detailed further below, an electrode disposed against surface 6a of the insulating component may be in contact with the electrode when the fuse is in the contracted configuration with the surfaces flush with one another and spaced from one another when the fuse is in the expanded configuration.

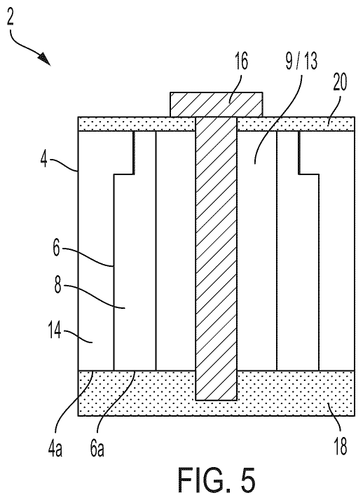

FIG. 5 illustrates one embodiment of a thermal fuse with both electrodes assembled with an insulating component in a contracted configuration. As shown in the figure, a second electrode 18 is disposed against the flush surfaces 4a and 6a of the assembled first electrode 4 and insulating component 6. As noted previously, a body of the insulating component may be received at least partially within an interior of the first electrode such that the through holes 9 and 13 of the electrode and insulating component may be coaxially located with one another. The first electrode may be in electrical contact with, and in some embodiments disposed against, the second electrode 18 via the surface 4a of the first electrode that is flush with the adjacent surface 6a of the insulating component when the thermal fuse is in the contracted configuration. The thermal fuse may also include a fastener 16 that applies a compressive axial force to the first electrode, second electrode, and insulating component to hold the components together, and in some embodiments, maintain the first electrode in electrical contact with the second electrode when the thermal fuses in the contracted configuration until a threshold temperature of the thermal fuse is exceeded. In the depicted embodiment, the fastener corresponds to a threaded fastener extending through the through holes 9 and 13 of the first electrode and the insulating component. The threaded fastener is threaded into a corresponding portion of the second electrode 18. To prevent shorting between the electrodes through the fastener, and insulating component, such as an insulating washer 20, may be disposed between a head of the threaded fastener and an adjacent portion of the first electrode in some embodiments.

During operation, current may flow through the thermal fuse from one electrode to the other. In the event of an overcurrent event occurring for a long enough duration, an environmental temperature being above a steady state operating temperature, or any number of other potential operating conditions occurring, a temperature of the thermal fuse may rise above a threshold temperature. When this occurs, the insulating component 6 may react to the rise in temperature by expanding in an axial direction. As the expansion increases, the fins 8 near the exposed portion of the insulating body 10, may apply an axially oriented force on opposing surfaces of the first electrode 4 and the second electrode 18 that biases the first and second electrodes away from each other. As the expansion continues a length of the fins 8 will become greater than a length of the fingers 14, or other portion of the first electrode, such that the first electrode becomes spaced apart from the first electrode by a gap (see FIG. 4B). In this expanded configuration, the electrical connection between the first electrode 4 and the second electrode 18 is broken and current stops flowing.

When a thermal fuse is in the expanded configuration, the operating temperature may be above a threshold temperature, and electrical current may not flow from the first electrode 4 to the second electrode 18. In this expanded configuration, the operating temperature may begin to fall due to the lack of electrical current traveling through the thermal fuse 2. Accordingly, the insulating component 6 may contract back towards its original length. Thus, the compressive force applied by the fastener 16 may cause the electrode fingers 14, or other portion of the first electrode 4, to be placed back in electrical contact with the second electrode 18 as the thermal fuse cools to a temperature below the threshold temperature.

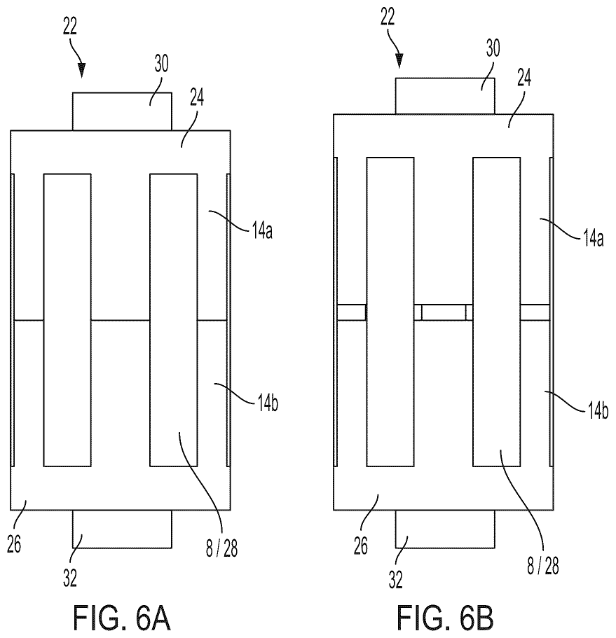

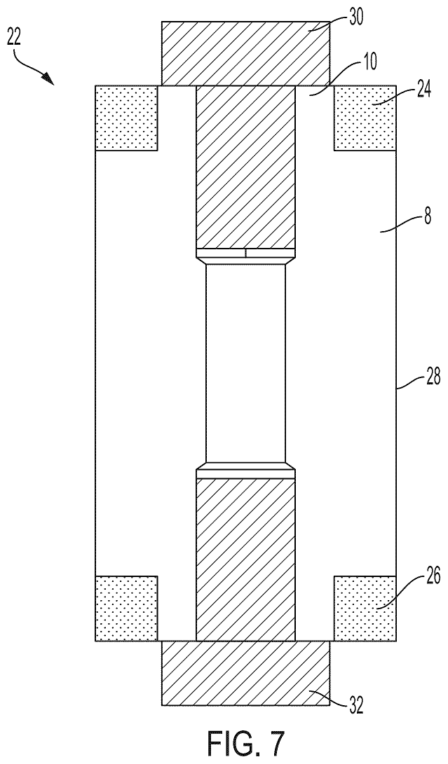

While FIGS. 1-5 depict one potential embodiment of a thermal fuse, other configurations are also contemplated. One such embodiment is illustrated by thermal fuse 22 of FIGS. 6A-7. Similar to the embodiment mentioned previously, thermal fuse 22 may comprise a first electrode 24, a second electrode 26, and an insulating component 28 disposed therebetween. The insulating component 28 may again comprise a set of fins 8 that extend radially outward from an insulating body and along at least a portion of a length of the insulating body. The insulating component may also include a hole extending axially through the insulating body similar to that described above. The fins of insulating component 28 may also be spaced inward from the opposing end portions of the insulating component. This leaves an annular portion of the insulating body extending axially outward from each end portion of the insulating component 28. Each of the first and second electrodes 24 and 26 may comprise a conducting body, a hole extending through the conducting body, and fingers 14a and 14b extending axially away from the conducting body. In the depicted embodiment, the fingers 14a and 14b of the first and second electrodes extend towards each other such that the fingers of each electrode are in contact in the contracted configuration shown in FIG. 6A with the fins 8 of the insulating component disposed in the spaces between adjacent sets of fingers.

As best shown in FIG. 7, the insulating component 28 is disposed between the first and second electrodes 24 and 26 in the holes extending there through the bodies of the electrodes. In some embodiments, a hole through the insulating body of the insulating component 28 may be concentric with the holes through each of the electrodes. As noted above, the fingers 14a and 14b of electrodes 24 and 26 may be interdigitated with the fins of the insulating component 28. Opposing portions of the electrodes may be in contact with opposing axially oriented faces of the fins disposed therebetween. In the depicted embodiment, a length of the two sets of electrode fingers is less than a corresponding length of the fins and a combined length of the two sets of electrode fingers may be equal to a length of the fins when the thermal fuses in the contracted configuration. Accordingly, corresponding electrode fingers of the two sets of electrode fingers may contact each other at a location between opposing ends of the fins when the thermal fuse is in the contracted configuration as shown in FIG. 6A. Correspondingly, in a manner similar to that described above relative to FIGS. 1-5, when a temperature of the thermal fuse, and more specifically a temperature of the fins, is greater than a threshold temperature, a length of the fins may be sufficiently greater than a combined length of the two sets of electrode fingers such that the corresponding sets of electrode fingers are spaced from one another by a gap as shown in FIG. 6B in the expanded configuration. This process is reversible as previously described when a temperature of the thermal fuse decreases to a temperature less than the threshold temperature.

In certain applications, it may be advantageous to include a first fastener 30, and a second fastener 32 to hold the assembly of a thermal fuse 22 together. As shown in FIG. 7, fasteners 30 and 32 may be, but are not limited to, a threaded fastener that attached the corresponding electrode to the insulating component 28. In the depicted embodiment, the separate fasteners do not directly contact one another or the other opposing electrode. Accordingly, a separate insulator may not be used in some embodiments. However, embodiments in which a single fastener extends between the two separate electrodes with one or more electrical insulators disposed between the fastener and the electrodes are also contemplated.

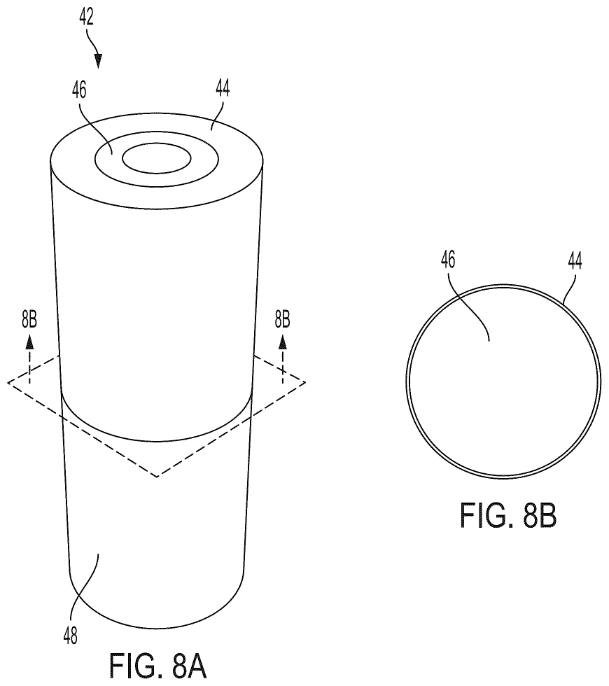

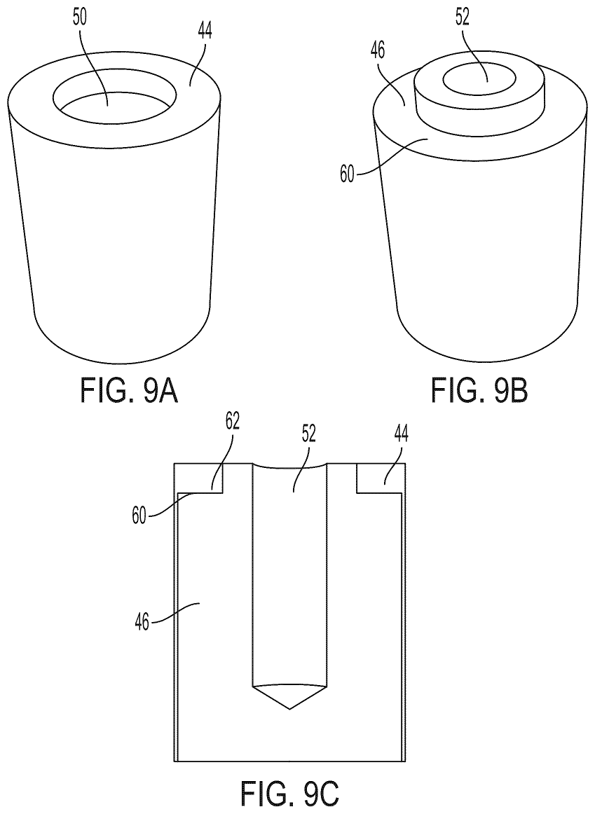

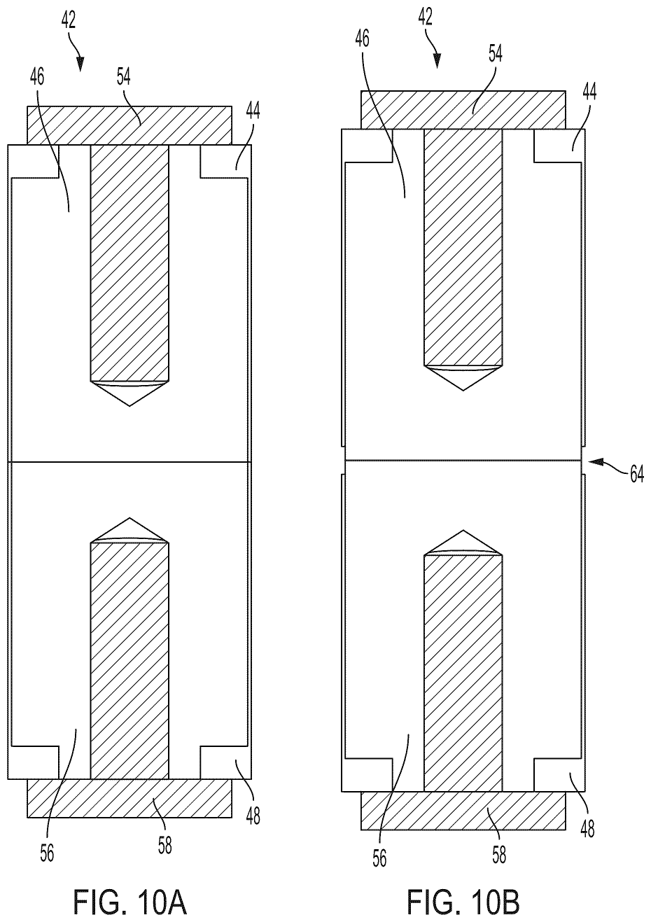

In the above embodiments, the electrodes include interdigitated fingers and fins to provide the desired selective electrical contact in the thermal fuse. However, it should be understood that the currently disclosed thermal fuses are not limited to constructions using interdigitated fingers and fins. Some embodiments may include electrodes without fingers and/or insulating components without fins. For example, in the embodiment shown in FIGS. 8A-10B, a thermal fuse may include annular or cylindrical components. In the embodiments of FIGS. 8A-10B, a thermal fuse 42 may include a first electrode 44, a first insulating component 46, a second electrode 48, and a second insulating component 56 (see FIGS. 9A-9B for the second insulating component 56). As shown in the cross-sectional view of FIG. 8B, the first insulating component 46 may include a cylindrical body and the first electrode 44 may include an annular body, or other appropriately shaped body with a cavity extending at least partially through the electrode body, such that the electrode includes an internal cavity that is sized and shaped to surround an outer perimeter of the first insulating component 46 to form a slip fit therebetween. In some embodiments and as shown in FIGS. 10A-10B, the second insulating component and the second electrode may be similarly arranged.

As shown in FIGS. 9A-9C, the first insulating component 46 may include a shoulder 60. The shoulder 60 may correspond to a projection that extends axially upwards relative to a top surface of insulating component. The shoulder may be configured to cooperate with a corresponding lip 62 formed in the first electrode 44 and that may extend radially inward such that it at least partially overlaps the shoulder of the insulating component when the components are assembled together. The shoulder 60 and lip 62 may cooperate to facilitate movement of the first electrode 44 during expansion and/or contraction of the first insulating component 46 due to the lip of the electrode being disposed on the shoulder of the insulating component. In some embodiments, the first electrode 44 may include a through hole 50, which may accommodate the projection extending axially upwards from the first insulating component 46. The first insulating component 46 may further include a bore 52 to configured to accept a fastener, which in some embodiments may be a threaded fastener, though other appropriate types of fasteners and/or other connections may also be used. As shown in FIGS. 10A-10B, a fastener 54 may be appropriately sized and shaped such that it maintains the lip of the electrode disposed against the corresponding shoulder of the insulating component during use. Specifically, the fastener may compress the lip between a head of the fastener and the shoulder, or other appropriate portion, of the insulating component. This may facilitate transmitting the movement of the insulating component to the electrode during expansion and contraction of the insulating component. In some embodiments, the bore 52 may be threaded to cooperate with a threaded fastener.

As shown in the cross-sectional views of FIGS. 10A-10B a first fastener 54 may be inserted into the first insulating component 46 and a second fastener may be inserted into the second insulating component 56. These separate insulating components may be held together using any appropriate type of connection (e.g., adhesives, fasteners, thermal diffusion based connections, clamps, and/or any other appropriate connection). Alternatively, while the insulating components are shown as separate components, in some embodiments, a single insulating component with the two opposing bores for attaching the two opposing fastener and electrodes may also be used as the disclosure is not so limited.

During operation, and as shown in FIG. 10A, when the thermal fuse 42 is in a closed or contracted configuration (e.g., when an operating temperature of the thermal fuse 42 is less than a threshold temperature), the first and second electrodes 44, 48 may be in physical and/or electrical contact around the periphery of the first and second insulating components, 46, 56. As shown in FIG. 10B, when the thermal fuse 42 is in an open or expanded configuration (e.g., when the operating temperature of the thermal fuse 42 is greater than the threshold temperature), the first and second insulating components 46, 56 may elongate more than the electrodes. Due to the electrodes being fixedly attached to opposing end portions of the insulating component, this causes a gap 64 to form between the first and second electrodes 44, 48. As will be appreciated, the gap 64 may break an electrical circuit between the first and second electrodes 44, 48. The thermal fuse 42 may return to the closed or contracted configuration of FIG. 10A (e.g., when the operating temperature is again reduced below the threshold temperature) by thermal contraction of the insulating components 46, 56.

It should be understood that the currently disclosed thermal fuses are not limited to the constructions, geometries, or specific shapes of the electrodes and insulating components disclosed herein. Therefore, the current disclosure includes any arrangement of an insulating component that may transition between an expanded configuration and a contracted configuration based on a temperature to selectively place a first electrode and a second electrode in contact with one another or space them apart to transition a thermal fuse between an open and closed configuration.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A thermal fuse comprising:
a first electrode;
a second electrode; and
an insulating component operatively coupled to the first electrode and the second electrode, wherein the insulating component is electrically insulating, wherein the insulating component is configured to place the first electrode in electrical contact with the second electrode when an operating temperature of the thermal fuse is less than a threshold temperature, and wherein the insulating component is configured to space apart the first electrode from the second electrode when the operating temperature is greater than the threshold temperature.

2. The thermal fuse of claim 1, wherein a coefficient of thermal expansion of the insulating component is greater than a coefficient of thermal expansion of at least one selected from the first electrode and the second electrode.

3. The thermal fuse of claim 1, wherein the insulating component is configured to expand in an axial direction to space apart the first electrode and the second electrode when the operating temperature is greater than the threshold temperature.

4. The thermal fuse of claim 1, wherein the insulating component is configured to contract in an axial direction to place the first electrode in electrical contact with the second electrode when the operating temperature is less than the threshold temperature.

5. The thermal fuse of claim 1, wherein one or more fins extend radially outward from a body of the insulating component, and wherein at least a portion of the first electrode and/or the second electrode is engaged with the one or more fins.

6. The thermal fuse of claim 1, wherein at least a portion of the insulating component and at least a portion of the first electrode are interdigitated.

7. The thermal fuse of claim 1, wherein the first electrode is biased towards the second electrode by a fastener.

8. The thermal fuse of claim 7, further comprising an insulator disposed between the fastener and the first electrode, and wherein the fastener extends from the first electrode to the second electrode.

9. The thermal fuse of claim 1, wherein the insulating component comprises a conductive material coated with an electrically insulating material.

10. A method of operating a thermal fuse, the method comprising:
expanding an insulating component to space apart a first electrode from a second electrode when an operating temperature of the thermal fuse is greater than a threshold temperature; and
contracting the insulating component to place the first electrode in electrical contact with the second electrode when the operating temperature of the thermal fuse is less than the threshold temperature.

11. The method of claim 10, wherein a coefficient of thermal expansion of the insulating component is greater than a coefficient of thermal expansion of at least one selected from the first electrode and the second electrode.

12. The method of claim 10, further comprising expanding the insulating component in an axial direction to space apart the first and second electrode.

13. The method of claim 10, further comprising contracting the insulating component in an axial direction to put the first electrode in electrical contact with the second electrode.

14. The method of claim 10, wherein one or more fins extend radially outward from a body of the insulating component, and wherein at least a portion of the first electrode and/or the second electrode is engaged with the one or more fins.

15. The method of claim 14, further comprising interdigitating at least a portion of the insulating component and at least a portion of the first electrode.

16. The method of claim 10, further comprising biasing the first electrode towards the second electrode.

17. The method of claim 10, wherein the insulating component comprises a conductive material coated with an electrically insulating material.

18. A thermal fuse comprising:
a first electrode;
a second electrode separate from the first electrode, wherein the first electrode and the second electrode are selectively movable between an extended configuration in which the first electrode and the second electrode are spaced apart and a contracted configuration in which the first electrode and the second electrode are in electrical contact; and
an insulating component disposed at least partially between the first electrode and the second electrode, wherein the insulating component is electrically insulating, and wherein a coefficient of thermal expansion of the insulating component is greater than a coefficient of thermal expansion of at least one selected from the first electrode and the second electrode.

19. The thermal fuse of claim 18, wherein the insulating component is configured to place the first electrode in electrical contact with the second electrode when an operating temperature of the thermal fuse is less than a threshold temperature, and wherein the insulating component is configured to space apart the first electrode from the second electrode when the operating temperature is greater than the threshold temperature.

20. The thermal fuse of claim 18, wherein the insulating component is configured to expand in an axial direction to space apart the first electrode and the second electrode when a temperature of the thermal fuse is greater than a threshold temperature.

21. The thermal fuse of claim 18, wherein the insulating component is configured to contract in an axial direction to place the first electrode in electrical contact with the second electrode when a temperature of the thermal fuse is less than a threshold temperature.

22. The thermal fuse of claim 18, wherein one or more fins extend radially outward from a body of the insulating component, and wherein at least a portion of the first electrode and/or the second electrode is engaged with the one or more fins.

23. The thermal fuse of claim 22, wherein at least a portion of the insulating component and at least a portion of the first electrode are interdigitated.

24. The thermal fuse of claim 18, wherein the first electrode is biased towards the second electrode by a fastener.

25. The thermal fuse of claim 18, wherein the insulating component comprises a conductive material coated with an electrically insulating material.

26. The thermal fuse of claim 18, wherein the coefficient of thermal expansion of the insulating component is greater than the coefficient of thermal expansion of both first electrode and the second electrode.
